(19) United States
(12) Patent Application Publication
(10) Pub. No.: US 2011/0221580 A1
(43) Pub. Date: Sep. 15, 2011

(54) MINIMIZATION OF POWER CONSUMPTION OF REMOTE CONTROLLED APPLIANCES

(75) Inventors: Sebastien Marsanne, Singapore (SG); Francesco Doddo, Lexington, MA (US); Hong-Shao Chen, Singapore (SG); Romel Estomata, Singapore (SG)

(73) Assignees: STMicroelectronics Asia Pacific PTE, Ltd., Singapore (SG); STMicroelectronics KK, Tokyo (JP)

(21) Appl. No.: 12/723,011

(22) Filed: Mar. 12, 2010

(51) Int. Cl. G08C 19/00

(52) U.S. Cl. 340/13.24

(57) ABSTRACT

Power consumption of an appliance under remote control is minimized. The appliance receives a wireless energy burst having a wireless magnetic resonating power coupling characteristic transmitted by a remote control device. The appliance is powered up from a powered-down state to a standby mode if the appliance is in the powered-down state when the wireless energy burst is received and the energy burst is of sufficient energy to activate a switched mode power supply of the appliance.

### BACKGROUND

Power consumption continues to be of concern by manufacturers and consumers alike, as evidenced by the growing importance of work by organizations such as ENERGY STAR, a joint program of the U.S. Environmental Protection Agency and the U.S. Department of Energy to facilitate the development of energy efficient products and practices. This concern extends to devices and appliances controlled by remote control devices, referred to herein as appliances, such as TVs, VCRs, DVD Players, components of Home Theater systems, etc.

A primary goal of programs such as ENERGY STAR is to reduce the amount of standby power used by appliances. While a laudable goal, much power is still wasted by appliances in a standby mode and it remains that the most energy saving solution is for appliances to turn themselves off after some period of time. In a powered-down state, an appliance does not consume any energy at all. There is no easy way for a consumer to power-up these devices from a powered-down state, however, given that the user must physically press the power ON switch or otherwise activate the power switch of the powered-down appliance or device.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. In these drawings, like reference numerals identify corresponding elements.

FIG. 1 is a block diagram of a system having an appliance and a remote control device for controlling the appliance, in accordance with various representative embodiments.

FIG. 2 is a block diagram illustrating the functional blocks of a remote control device disclosed in the system of FIG. 1, in accordance with various representative embodiments.

FIG. 3 is an illustration of the magnetic resonator of the wireless power transmitter of FIG. 2, in accordance with various representative embodiments.

FIG. 4 is a block diagram illustrating the functional blocks of an appliance disclosed in the system of FIG. 1, in accordance with various embodiments.

FIG. 5 is a functional block diagram of an exemplary appliance, in accordance with various embodiments.

FIG. 6 is a functional block diagram of a switched mode power supply of an appliance, in accordance with various embodiments.

FIG. 7 is a flowchart that illustrates device methodology in accordance with various embodiments.

FIG. 8 is a flowchart that illustrates system methodology in accordance with various embodiments.

### DETAILED DESCRIPTION

As shown in the drawings for purposes of illustration, a remote control device, system comprised of a remote control device and appliance controlled by the remote control device, and methodology provide for enhanced energy savings and efficiency of remotely controlled appliances. A remote control device has a wireless power transmitter operable to transmit a wireless energy burst having a wireless magnetic resonating power coupling characteristic; a processor and control element; and a user interface having a power ON activation element. In response to activation of the power ON activation element of the user interface, the processor and control element controls the wireless power transmitter to transmit the wireless energy burst having the wireless magnetic resonating power coupling characteristic.

A system is comprised of an appliance with a power antenna receiver, a switched mode power supply, and a processor and control element, and having a standby mode and an operational mode; and a remote control device with a wireless power transmitter operable to exercise remote control of the appliance. In response to the wireless power transmitter of the remote control transmitting a wireless energy burst that is received by the power antenna receiver of the appliance when the appliance is in a powered-down state, the processor and control element controls the switched mode power supply to power on the appliance from the powered-down state to a standby mode.

In accordance with a method for minimizing power consumption of an appliance operated by a remote control device, the appliance receiving a wireless energy burst; and a switched mode power supply of the appliance powering up the appliance to a standby mode if the appliance is in a powered-down state when the wireless energy burst is received. Further, a process and control element of the appliance controlling the switched mode power supply of the appliance to power on the appliance from the powered-down state to the standby mode when the appliance is in a powered-down state and the wireless energy burst is received.

In accordance with a method of power consumption of an appliance operated by a remote control device in a system comprised of the appliance and the remote control device, the remote control device transmitting a wireless energy burst; the appliance receiving the wireless energy burst; and powering up the appliance from a powered-down state to a standby mode if the appliance is in the powered-down state when the wireless energy burst is received.

Using the drawings, the various embodiments of the present invention, including preferred embodiment(s) will now be explained. In the following detailed description and in the several figures of the drawings, like elements are identified with like reference numerals.

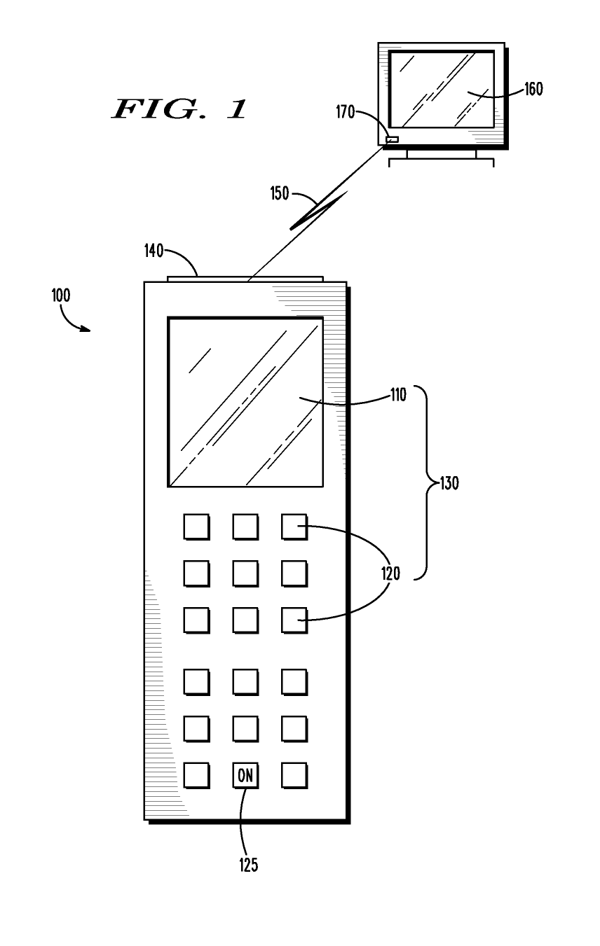

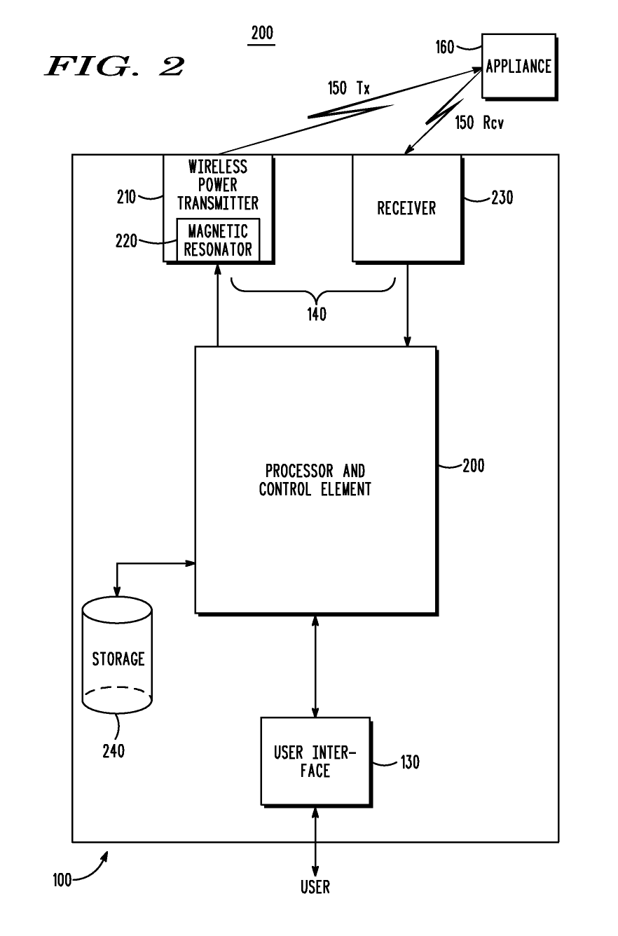

As shown in the system of FIG. 1, a representation of a system including a remote controller 100, also referred to as a remote controller, remote commander, remote control device, or the like, and an appliance or appliance 160 controlled by the remote controller 100; the appliance may be a television set, VCR, a DVD Player, Home Theater components or other device operable to be remotely controlled by remote controller 100. The communications link 150 between the remote controller 100 and the appliance 160 maybe a bi-directional, two-way link during a normal operating mode of operation. Bi-directional communications is commonly used in audio applications, LCD, OLED and LED screens, etc. The functional block diagram of the remote controller 100 of FIG. 2 illustrates the functional relationship between the user interface, processor and control element, wireless power transmitter and receiver elements. The remote control device 100 may be a portable remote controller used by a user to control variable types of appliances, such as a portable hand-operated device.

The remote controller 100 has a user interface 130 through which a user may remotely control operation of the appliance(s); a processor and control element 200 that processes instructions received from the user via the user interface and generates control signals in accordance with those instructions; a receiver 230 of the remote controller communications unit 140 that receives signals from the appliance(s) and provides those received signals to the processor and control element; and a wireless power transmitter 210 of communications unit 140 that transmits the control signals generated by the processor and control element to the appliance(s) under control of the processor and control element.

The remote controller 100 has a user interface 130 by which the user may send and receive information. The user interface features a display 110, for example a liquid crystal display (LCD), on which data and information received from the appliance or input using the keypad 120 may be displayed. For example, in the case of a television as the appliance, the display 110 may display a menu or program guide. Such information can assist a viewer in navigating among the wide variety of available programming. For example, electronic program guides that are displayed on a particular channel are common in cable and satellite systems as a way of informing viewers as to what programming is being shown.

The user interface also features a plurality of keys or buttons 120 with which a user can enter instructions to be sent to the appliance 160 or instructions to be received by the processor and control element 200 of the remote controller of FIG. 2, as will be described. In particular, ON button 125 of the user interface 130 can be used to transmit a wireless energy burst having a wireless magnetic resonating power coupling characteristic, described below. The energy burst is a temporary energy burst of power and duration sufficient to be received by the power antenna receiver within mid-range proximity, limiting exposure to persons in proximity of the burst. For example, the wireless energy burst may range from approximately 200 to 400 mW and the energy pulse of duration approximate the time it takes to press a remote control button.

The communications unit 140 of the remote controller 100 includes a wireless power transmitter 210 and a receiver 230 for both sending and receiving data signals from the appliance 160, illustrated in this embodiment by way of example and not limitation as a television set. The appliance 160 is equipped with a similar communications unit 170 which includes both a receiver and a transmitter for receiving signals from the remote controller 100 and transmitting signals to the remote controller. The signaling between the appliance 160 and the remote controller 100 is wireless magnetic resonating transmission.

In response to a user activating the power ON activation element 125 of the user interface 130, the processor and control element controls the wireless power transmitter 210 and its magnetic resonator 220 to transmit the wireless energy burst having the wireless magnetic resonating power coupling characteristic.

During normal operation, there is a two-way communications link between the appliance 160 and the remote controller 100 during which the appliance operates normally in an operational mode. The appliance 160 enters a standby mode after some period of inactivity in order to conserve power. After some period of time, however, the appliance will self-power down to a powered-down mode to further save power.

In order to power the appliance back to a standby mode from a powered-down state, in accordance with the various embodiments, a user of the remote controller 100 may activate a power ON feature of the remote controller, such as by pressing ON button 125 of user interface 130, to cause the wireless power transmitter 210 of remote controller 100 to beam a wireless energy burst having the wireless magnetic resonating power coupling characteristic that, when received by a power antenna receiver of appliance 160 while appliance 160 is in a powered-down state, will cause appliance 160 to power on from a powered-down state to its standby mode. The energy burst transmitted by remote controller 100 causes a processor and control element of appliance 160 to control a switched mode power supply, such as a bi-stable power switch, of appliance 160 to power up the device to the standby mode.

Once the appliance 160 is powered back up to its standby mode, it is operable to resume normal operation in the operational mode after a predetermined period of time. And, after a subsequent period of inactivity of the appliance, the switched mode power supply powers down the appliance causing it to go from the standby mode to the powered-down state.

The wireless energy burst transmitted by the remote controller 100 has a wireless magnetic resonating power coupling characteristic that is beamed within a mid-range distance of the remote control device. In accordance with wireless magnetic resonating technology, such as that available from WiTricity Corporation of Watertown, Mass., USA, the wireless energy burst is beamed within a mid-range distance that may range from approximately centimeters to several meters.

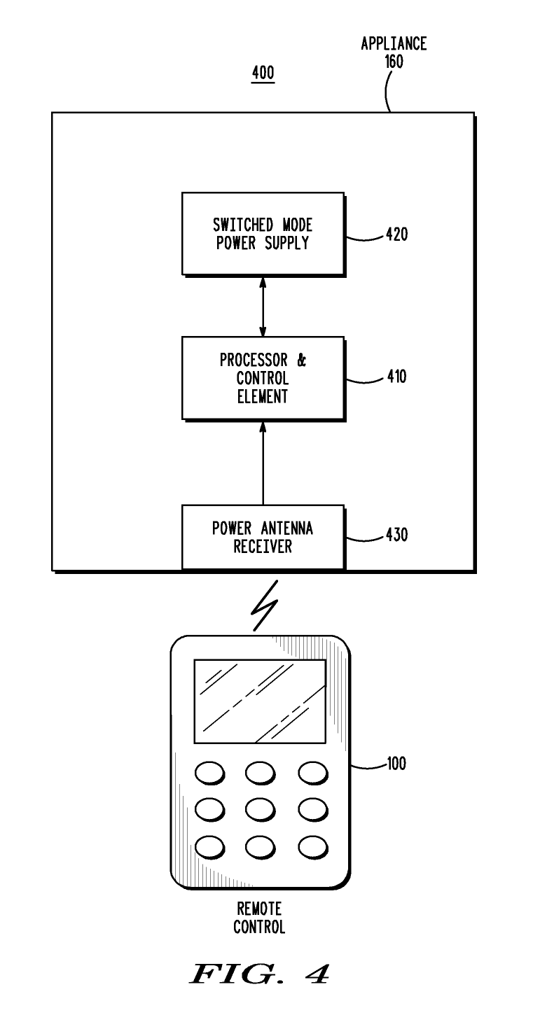

Wireless power transmitter 210 in certain embodiments has a magnetic resonator element 220 with a resonating frequency; the resonating frequency of the power transmitter 210 may be matched by the frequency of the receiver of the appliance, such as power antenna receiver element 430 of FIG. 4. A benefit of the resonating frequency is that it allows each appliance to be selectively powered on. Thus a remote controller device of one manufacturer may selectively power up an appliance device made by another manufacturer if the resonating frequency of the two devices match. In way, a user using a remote controller manufactured by Manufacturer X can power up a television manufactured by Manufacturer Y where the resonating frequency of the wireless energy burst transmitted by the remote controller matches the resonating frequency of the receiver antenna of the television.

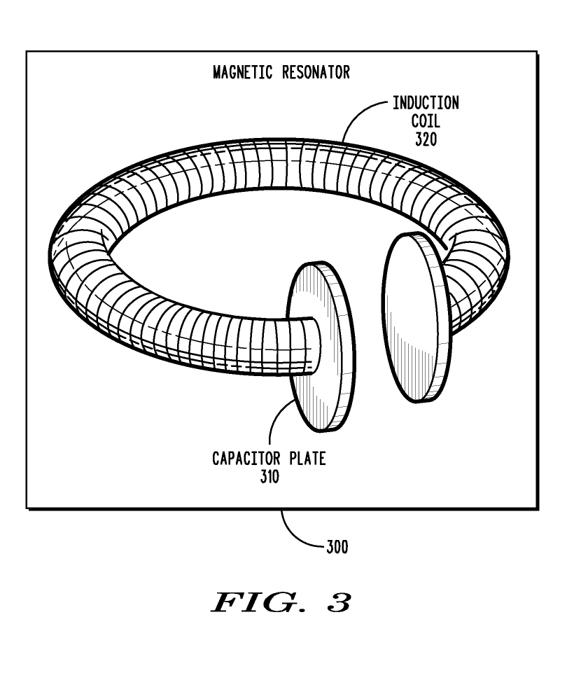

Referring now to FIG. 3, magnetic resonator 220 of wireless power transmitter is further represented by magnetic resonator element 300. The magnetic resonator 300 has a capacitance plate element 310 and an inductor coil element 320 and is characterized by a resonating frequency determined by the shape of the inductor coil element 320. It is noted that the capacitance plate may also be comprised of capacitor elements or capacitance distributed along the inductance of inductor coil element 320. The magnetic resonator element 300 as the wireless magnetic resonating power coupling characteristic beamed by the wireless power transmitter 210 of remote controller 100. The wireless energy burst may be beamed within a mid-range distance of the remote controller 100; the mid-range distance may range from approximately a centimeter to several meters. The appliance 160 will be within this range to receive the wireless energy burst; the power antenna receiver 430 of the appliance will receive this wireless burst of energy, as shown in FIG. 4.

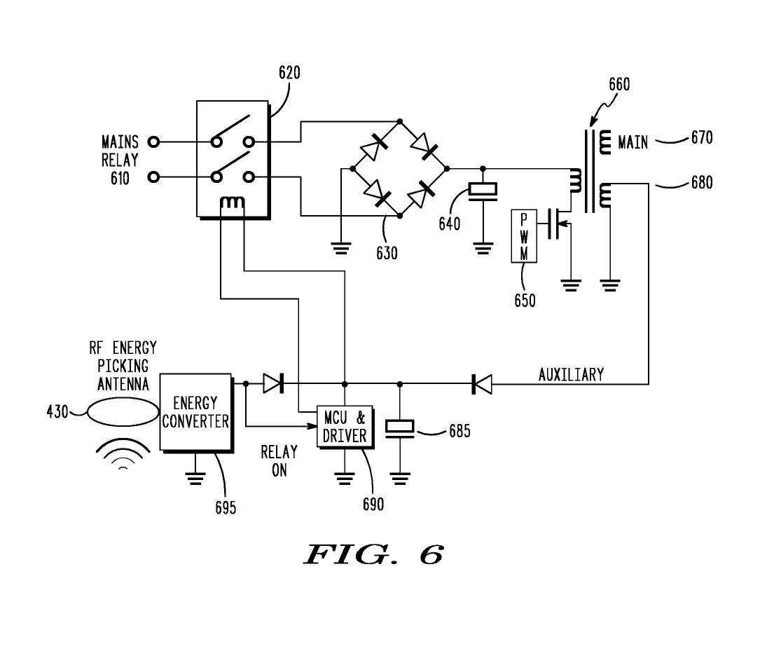

Referring now to FIG. 4, a block diagram of the functional elements of an appliance device 160 in communication with remote controller 100 of system 400 is shown. Appliance 160 comprises a switched mode power supply 420 and a power antenna receiver 430 in operable communication and under the control of processor and control element 410. As previously described, the appliance may be a television set, VCR, a DVD Player, Home Theater components or other device operable to be remotely controlled by remote controller 100. Appliance 160 has a standby mode and an operational mode. Remote control device 100 has a wireless power transmitter operable to exercise remote control of the appliance. In response to the wireless power transmitter of the remote controller 100 transmitting a wireless energy burst that is received by the power antenna receiver 430 of appliance 160 when in a powered-down state, the processor and control element 410 controls the switched mode power supply 420 to power on the appliance from the powered-down state to a standby mode. The switched mode power supply 420 is further illustrated in FIG. 6 as a bi-stable power switch, in an exemplary embodiment.

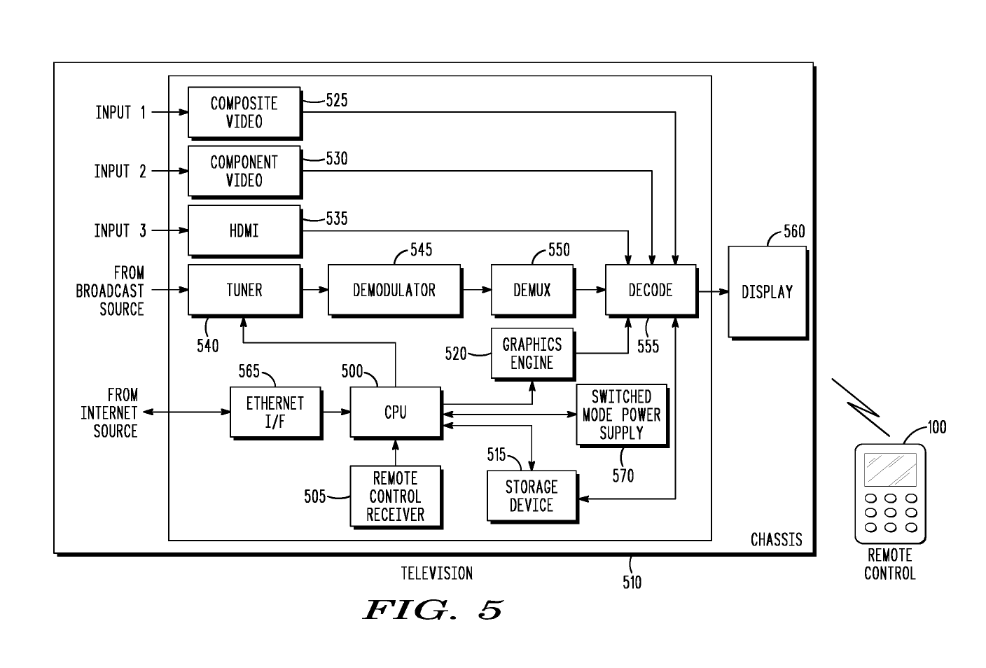

Referring now to FIG. 5, a block diagram of an exemplary appliance device is shown, in this case a television. Appliance 510 has a number of components and functional elements that enable it to function. These include central processing unit or CPU 500 (representative of the processor and control element 310 of FIG. 3), remote control receiver 505 for receiving communications from remote control 100 (representative of power antenna receiver 430 of FIG. 4), Ethernet I/F module 565, storage device 515, a graphics engine 520, composite video input module 525, component video input module 530, HDMI interface input 535, tuner 540, demodulator 545, demux 550, decoder 555 and switched mode power supply 570. The appliance is able to communicate with remote commander/controller 100.

The exemplary appliance 510 of FIG. 5 is shown as a television. A television typically will have both analog and digital inputs. Analog inputs are commonly, but not exclusively, composite and component; VGA (D-Sub-15) are applicable for analog as well. Digital interfaces may be, but not limited to, Ethernet, IEEE-1394, HDMI, and USB. Activity on any of the interfaces 525, 530, 535 can be detected by the television. For example, it is possible to detect the presence or absence of synchronization pulses in analog signals. With digital inputs, on the other hand, absence or presence of signals is detectable by absence or presence of information within the digital signal or absence of the digital signal. Many of the digital interfaces have handshaking functions that are used to detect presence of an active input or output. The television merely needs to determine whether or not any of its inputs are active through any of these or other methods.

The television appliance, then, is operable to receive content from a variety of sources (525, 530, 535, 540, 565) at remote control receiver element 505 and, as controlled by programmed processor and control element 500, to display received information or content during a normal mode of operation of the appliance.

As described herein, content is one or more of audio, visual and audio/visual content and may come from a variety of sources, such as a set top box, to be displayed by display 560 during a normal operating mode. It may be, for example, movies, games, videos, advertisements, etc.

Referring now to FIG. 6, a switched mode power supply 600 in accordance with various embodiments is illustrated. Antenna receiver 430 is an RF energy picking antenna that detects the energy burst transmitted by wireless power transmitter 210 of remote controller 100. As previously mentioned, the frequency of power antenna receiver 430 may be matched to the resonating frequency produced by magnetic resonator 220 of wireless power transmitter 210.

Switched mode power supply 600 has the following elements configured and arranged as shown in FIG. 6: mains relay 610, switch 620, diode bridge 630, capacitor 640, pulse width modulator (PWM) 650, a transformer with center tap 660 having a main winding 670 and an auxiliary winding 680, capacitor 685, microcontroller unit (MCU) and driver element 690, and energy converter element 695.

Switched mode power supply 600 illustrates one implementation to allow the device to “wakeup” from a powered-down state to a standby mode using a relay approach. When the power supply is OFF, there is no current drawn by the main side 670. The mains relay 610 turns ON only when there is enough energy picked by up RF energy picking antenna 430 and supplied to MCU and driver element 690. When enough energy is received, the MCU and driver circuit element 690 turns on the mains relay 620 and the supply to the MCU and driver element 690 is provided from the auxiliary winding 680 of the main power supply transformer. Even with the energy converter 695 OFF, the MCU and driver element 690 will continue to be kept operating by this auxiliary supply. Power consumption as low as approximately 120 mW has been achieved. Reference is made to printed circuit board relay PCT Power Relay G6DS by Omron as a miniature relay with single pole switching capability as an exemplary switching power supply device.

It is noted that the microcontroller unit MCU may be represented by discrete components, such as discrete analog or digital components, that provide the same functionality.

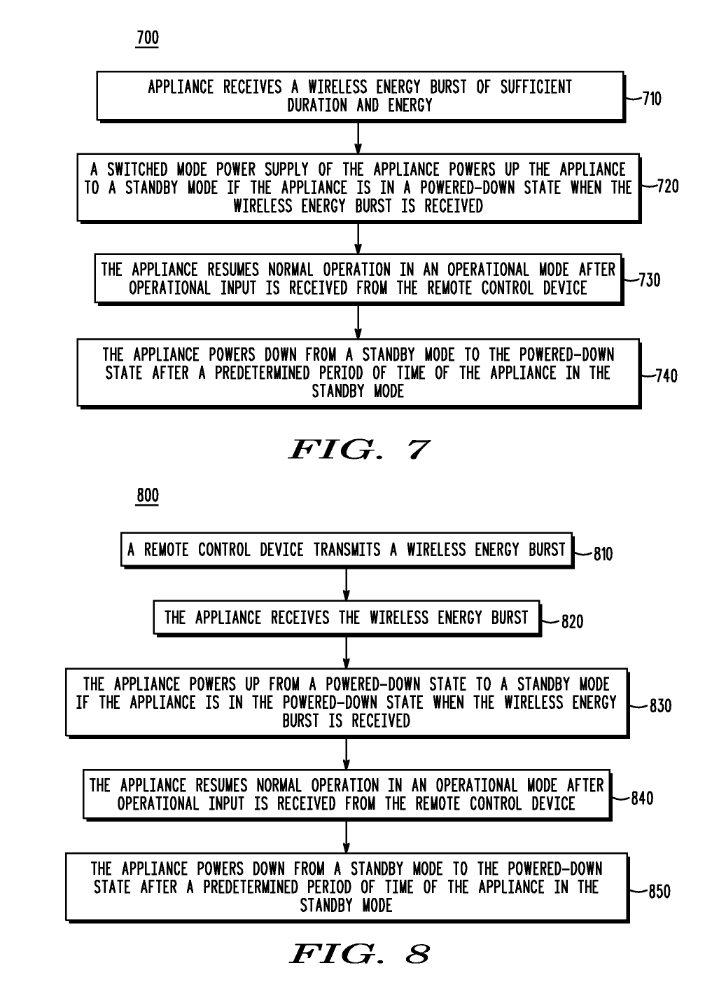

Reference is now made to FIGS. 7 and 8 for illustration of methodology in accordance with various embodiments described herein. In flowchart 700 of FIG. 7, a methodology from the perspective of an appliance is shown. The appliance receives a wireless energy burst at Block 710. The wireless energy burst is a magnetic resonating wireless transmission beamed by the wireless power transmitter of the remote control and must be of sufficient energy to activate the switched mode power supply of the appliance. The appliance must also be within range of the remote controller to receive the energy burst. In expected configuration, the appliance and remote controller will be separated a mid range distance, such as form centimeter(s) to several meters.

A switched mode power supply of the appliance powers up the appliance to a standby mode if the appliance is in a powered-down state when the wireless energy burst is received, at Block 720. As discussed, this may further comprise a processor and control element of the appliance controlling the switched mode power supply of the appliance to power on the appliance from the powered-down state to the standby mode when the appliance is in a powered-down state and the wireless energy burst is received. Optionally, if operational input is received while in the standby mode, such as from a user of the remote controller, the appliance can resume normal operation in an operational mode, at Block 730. At Block 740, the appliance may power down from its standby mode to a powered-down state after it has been in standby mode a predetermined period of time.

Flowchart 800 of FIG. 8 illustrates a methodology from the perspective of a system having a remote controller and an appliance. At Block 810, a remote control device transmits a wireless energy burst 810 that is received by an appliance at Block 820. Again, the energy burst has to be sufficient to activate the switched mode power supply of the appliance. A power antenna receiver of the appliance receives the wireless energy burst. The antenna receiver may be shaped so as to have the same resonant frequency as the magnetic resonator of the wireless power transmitter of the remote controller. At Block 830, the appliance powers up from a powered-down state to a standby mode if the appliance is in the powered-down state when the wireless energy burst is received. A processor and control element of the appliance controls a switched mode power supply of the appliance to power on the appliance from the powered-down state to the standby mode when the appliance is in a powered-down state. The switched mode power supply of the appliance thus powers up the appliance to a standby mode if the appliance is in a powered-down state when the wireless energy burst is received. At Block 840, the appliance can resume normal operation in an operational mode after operational input is received from the remote control device. As mentioned above, this may be selections made by a user interfacing with the user interface of the remote controller device in the normal manner. Optionally, at Block 850 the appliance powers down from a standby mode to the powered-down state after the appliance has been in the standby mode a predetermined period of time.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A remote control device, comprising:
a wireless power transmitter operable to transmit a wireless energy burst having a wireless magnetic resonating power coupling characteristic;
a processor and control element; and
a user interface having a power ON activation element;
wherein in response to activation of the power ON activation element of the user interface, the processor and control element controls the wireless power transmitter to transmit the wireless energy burst having the wireless magnetic resonating power coupling characteristic.

2. The device of claim 1, wherein the wireless power transmitter further comprises a magnetic resonator having a resonating frequency.

3. The device of claim 2, wherein the magnetic resonator comprises an inductor coil element and a capacitance plate element.

4. The device of claim 3, wherein the shape of the inductor coil element determines the resonating frequency of the wireless power transmitter.

5. The device of claim 1, wherein the wireless energy burst having the wireless magnetic resonating power coupling characteristic is beamed within a mid-range distance of the remote control device.

6. The device of claim 5, wherein the mid-range distance ranges from approximately centimeters to several meters.

7. A system, comprising:
an appliance with a power antenna receiver, a switched mode power supply, and a processor and control element, and having a standby mode and an operational mode; and
a remote control device operable to exercise remote control of the appliance and having a wireless power transmitter operable to transmit a wireless energy burst having a wireless magnetic resonating power coupling characteristic;
wherein in response to the wireless power transmitter of the remote control transmitting a wireless energy burst that is received by the power antenna receiver of the appliance when the appliance is in a powered-down state, the processor and control element controls the switched mode power supply to power on the appliance from the powered-down state to a standby mode.

8. The system of claim 7, wherein the wireless energy burst beamed by the wireless power transmitter of the remote control is a magnetic resonating wireless transmission.

9. The system of claim 7, wherein the wireless power transmitter further comprises a magnetic resonator having a resonating frequency.

10. The system of claim 9, wherein the magnetic resonator comprises an inductor coil element and a capacitance plate element and wherein the shape of the inductor coil element determines the resonating frequency of the wireless power transmitter.

11. The system of claim 9, wherein the remote control device further comprises:
a processor and control element; and
a user interface having a power ON activation element;
wherein in response to a user activating the power ON activation element of the user interface, the processor and control element controls the wireless power transmitter to transmit the wireless energy burst having the wireless magnetic resonating power coupling characteristic.

12. The system of claim 7, wherein the wireless energy burst having the wireless magnetic resonating power coupling characteristic is beamed within a mid-range distance of the remote control device.

13. The system of claim 12, wherein the mid-range distance ranges from approximately centimeters to several meters.

14. The system of claim 12, wherein the appliance is within the mid-range distance to receive the wireless energy burst.

15. The system of claim 12, wherein the mid-range distance is in the range of approximately one centimeter to several meters.

16. A method of minimizing power consumption of an appliance, comprising:
the appliance receiving a wireless energy burst having a wireless magnetic resonating power coupling characteristic; and
powering up the appliance from a powered-down state to a standby mode if the appliance is in the powered-down state when the wireless energy burst is received.

17. The method of claim 16, further comprising a power antenna receiver of the appliance receiving the wireless energy burst.

18. The method of claim 16, further comprising a processor and control element of the appliance controlling a switched mode power supply of the appliance to power on the appliance from the powered-down state to the standby mode when the appliance is in a powered-down state when the wireless energy burst is received.

19. The method of claim 16, further comprising the appliance resuming normal operation in an operational mode after operational input is received from a remote control device.

20. The method of claim 16, further comprising a remote control device transmitting the wireless energy burst.

21. The method of claim 20, wherein the wireless energy burst is beamed by a wireless power transmitter of a remote control device over a mid-range distance and the appliance is within the mid-range distance to receive the wireless energy burst.

22. The method of claim 21, wherein the mid-range distance is more than one meter.
